(19) United States
(12) Patent Application Publication
(10) Pub. No.: US 2017/0024751 A1
(43) Pub. Date: Jan. 26, 2017

(54) FRESH PRODUCTION FORECASTING METHODS AND SYSTEMS

(71) Applicant: Wal-Mart Stores, Inc., Bentonville, AR (US)

(72) Inventors: Willie Montgomery, III, Rogers, AR (US); Venkataraja Nellore, Bentonville, AR (US)

(21) Appl. No.: 15/206,538

(22) Filed: Jul. 11, 2016

Related U.S. Application Data
(60) Provisional application No. 62/196,245, filed on Jul. 23, 2015.

(51) Int. Cl. G06Q 30/02

(52) U.S. Cl. CPC G06Q 30/0202; G06Q 30/0201

(57) ABSTRACT

In some embodiments, methods and systems of forecasting consumer demand for products at fresh food departments of a grocery store include determining an actual past demand for the product by obtaining a total number of the product sold by the fresh food department in one or more weeks preceding a current week, then calculating a seasonality index for the one or more weeks, deseasonalizing the total number of the product sold in the one or more weeks based on the calculated seasonal index to obtain an initial weekly demand forecast for the product during a single week following the current week, and adding a buffer quantity of the product to the initial weekly demand forecast for the product during the single week following the current week to obtain a refined weekly demand forecast for the product for the single week following the current week.

### CROSS-REFERENCE TO RELATED APPLICATION

This application claims the benefit of U.S. Provisional Application No. 62/196,245, filed Jul. 23, 2015, and is incorporated herein by reference in its entirety.

### TECHNICAL FIELD

This invention relates generally to forecasting demand for products at store locations and, in particular, to systems and methods for forecasting demand for fresh food products at grocery store locations.

### BACKGROUND

Retail locations typically forecast demand for a product in fresh product departments such as Bakery, Deli, Meat, and Seafood by taking into account an average of the units, packs, or pounds of the product sold over the past six weeks, then taking out the high and the low values to arrive at a moving average of the past four weeks. Such forecasting of product demand does not provide enough information to enable the fresh product departments to accurately forecast product demand for the coming week and to determine how much product should be prepared for the coming week.

Another disadvantage of conventional fresh product demand forecast methodology is that it does not account for the seasonality of fresh product sales at grocery locations. For example, product sales numbers during holiday weeks may be disproportionately higher than the sales numbers during non-holiday weeks. Thus, forecasting demand for fresh products without accounting for the seasonality in holiday and non-holiday weeks often leads to a product demand calculation that results in unnecessary overproduction of the fresh products. Yet another disadvantage of conventional fresh product demand forecast methodology is that it typically does not account for throws, i.e., amount or number of fresh food products thrown away or not sold to consumers for various reasons. Forecasting demand without accounting for throws may lead to undesired situations where the forecasted demand leads to underproduction of the fresh products.

### BRIEF DESCRIPTION OF THE DRAWINGS

Disclosed herein are embodiments of systems, apparatuses and methods pertaining to methods and systems for forecasting demand for fresh food products at grocery locations. This description includes drawings, wherein:

FIG. 1 is a diagram of a fresh product demand forecasting system at a grocery location in accordance with some embodiments.

FIG. 2 is a functional diagram of an exemplary computing device configured for fresh production planning in accordance with several embodiments.

FIG. 3 is a flow chart diagram of a process of forecasting consumer demand for a product at a fresh food department of a grocery location in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, methods and systems are provided herein useful for forecasting consumer demand for products at fresh food departments of a grocery store, and enabling the fresh food departments of the grocery store to accurately determine an appropriate amount of the product to prepare for the coming week.

In one embodiment, a computer-implemented method of forecasting consumer demand for a product at a fresh food department of a grocery store includes: determining, using a computing device including a processor, an actual past demand for the product by obtaining a total number of the product sold by the fresh food department in at least one week preceding a current week; calculating, using the computing device, a seasonality index for the at least one week; deseasonalizing, using the computing device, the total number of the product sold in the at least one week based on the calculated seasonal index to obtain an initial weekly demand forecast for the product during a single week following the current week; and adding, using the computing device, a buffer quantity of the product to the initial weekly demand forecast for the product during the single week following the current week to obtain a refined weekly demand forecast for the product for the single week following the current week.

In another embodiment, a computer-based system for forecasting consumer demand for a product at a fresh food department of a grocery store includes: a computing device including a control circuit having a processor; a network interface configured to retrieve a total number of the product sold by the fresh food department from a database; a memory coupled to the control circuit and storing computer instructions that when executed by the control circuit are configured to: determine an actual past demand for the product by obtaining from the database the total number of the product sold by the fresh food department in at least one week preceding a current week; calculate a seasonality index for the at least one week; deseasonalize the total number of the product sold in the at least one week based on the calculated seasonal index to obtain an initial weekly demand forecast for the product during a single week following the current week; and add a buffer quantity of the product to the initial weekly demand forecast for the product during the single week following the current week to obtain a refined weekly demand forecast for the product for the single week following the current week.

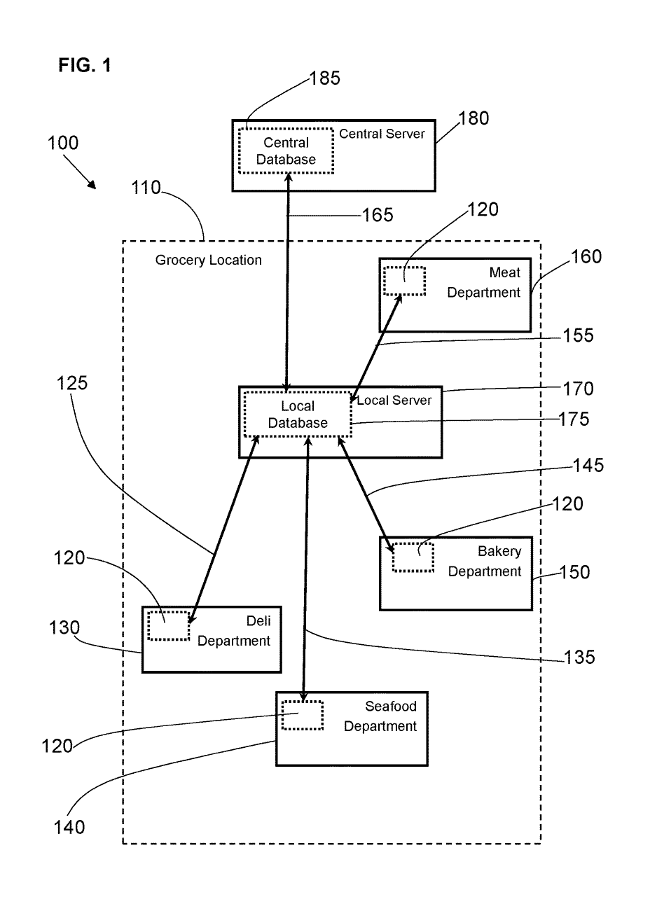

Referring to FIG. 1, one embodiment of a system 100 for forecasting consumer demand for products at a fresh food department of a grocery store or grocery location 110 is shown. The grocery store or grocery location 110 may be any place of business such as a supermarket or the like where consumer food products (e.g., deli food items, meat food items, bakery food items, and seafood items) are freshly prepared and/or sold. The exemplary system 100 includes an electronic computing device 120 available at each of the fresh product departments of the grocery location 110 and configured to receive and/or transmit information regarding one or more products to be produced at fresh product departments of the grocery location 110. FIG. 1 shows the deli department 130, the seafood department 140, the bakery department 150, and the meat department 160 as the exemplary fresh food departments of the grocery location 110, but it will be understood that the system 100 can be advantageously used with any department of the grocery location 110 where fresh food products are prepared and/or packaged and/or offered for sale to the consumers.

The exemplary system 100 as shown in FIG. 1 may include a local (on-site) server 170 in two-way communication via connections 125, 135, 145, and 155 with the electronic computing devices 120 located at the deli department 130, seafood department 140, bakery department 150, and meat department 160, respectively. The local server 170 may be a Tomcat-type server or the like. While the local server 170 may be in two-way communication with a central server 180 remote to the grocery location 110 via a connection 165 as shown in FIG. 1, it will be appreciated that the electronic computing device 120 may be in two-way communication directly with the central server 180 over a wired or wireless connection instead of being connected to the central server 180 via the local server 170. It will also be appreciated that the local server 170 may communicate with the central server 180 directly or via an intermediate server or other device. It will likewise be appreciated that the system 100 may be confined to the grocery location 110 such that neither the electronic computing device 120 nor the local server 170 is required to communicate with a device or server remote to the grocery location 110.

As shown in FIG. 1, the local server 170 may include a local database 175 and the central server 180 may include a central database 185. The local database 175 and/or the central database 185 may be Cassandra-type databases that may store historical data relating to inventory and sales of the products at the fresh food departments 130, 140, 150, and 160 of the grocery location 110, including but not limited to data pertaining to consumer demand for the products at the fresh food departments 130, 140, 150, and 160 of the grocery location 110 (e.g., data pertaining to past sales of the products at each of the fresh food departments 130, 140, 150, and 160 of the grocery location 110).

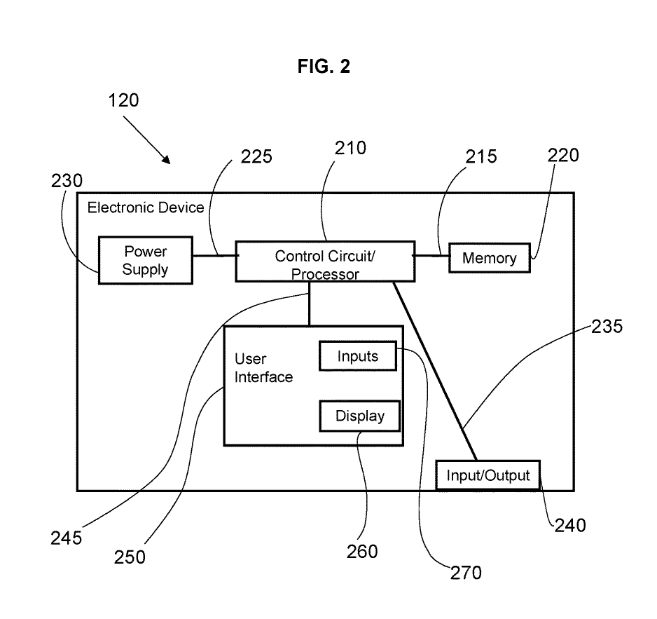

The electronic computing device 120 may be a stationary, portable, or hand-held electronic device including a processor (e.g., a computing device), for example, a desktop computer, a laptop computer, a tablet, a mobile phone, or any other device configured for data entry and communication with the local server 170 and/or the central server 180. The electronic computing device 120 may be configured as a Tomcat-type client or the like. An exemplary electronic computing device 120 depicted in FIG. 2 includes a control circuit 210 including a processor (for example, a microprocessor or a microcontroller) electrically coupled via a connection 215 to a memory 220 and via a connection 225 to a power supply 230. The control circuit 210 of the electronic computing device 120 is also electrically coupled via a connection 235 to an input/output 240 that can receive signals (e.g., commands, inventory database information) from the local (on-site) server 170 or from any other source, for example, the central server 180 located remotely to the grocery location 110 that can communicate with the electronic computing device 120, for example, via a wired or wireless connection. The input/output 240 of the electronic computing device 120 can also send signals (e.g., information identifying a fresh food product to be prepared) to various devices in communication with the electronic computing device 120, for example, the local server 170, central server 180, or any other device in wired or wireless communication with the electronic computing device 120.

In the embodiment shown in FIG. 2, the control circuit 210 of the electronic computing device 120 is electrically coupled via a connection 245 to a user interface 250, which may include a visual display or display screen 260 (e.g., LED screen) and/or inputs 270 that provide the user interface 250 with the ability to permit a user such as an associate at the fresh food department of the grocery location 110 to manually control the electronic computing device 120 by inputting commands, for example, via touch-screen and/or button operation or voice commands. The display screen 260 can also permit the user to see various menus, options, and/or alerts displayed by the electronic computing device 120 in connection with forecasting a demand for production of products at the fresh food departments 130, 140, 150, and 160 of the grocery location 110. The inputs 270 may permit a user to navigate through the on-screen menus, historical data relating to past consumer demand for the products at the fresh food departments 130, 140, 150, and 160 of the grocery location 110, and next week demand forecasts for the products at the fresh food departments 130, 140, 150, and 160 of the grocery location 110.

In some embodiments, in addition to the on-screen menus, historical data relating to past consumer demand for the products at the fresh food departments 130, 140, 150, and 160 of the grocery location 110, and next week demand forecasts for the products at the fresh food departments 130, 140, 150, and 160 of the grocery location 110, the user interface 250 of the electronic computing device 120 may be configured to display a weather forecast to a user for the next one to two days (or three to four days), since severe weather (e.g., thunderstorm and/or snow) are known to affect consumer demand for products at the fresh food departments 130, 140, 150, and 160 of the grocery location 110. For instance, an indication by the electronic computing device 120 (e.g., a displayed informational icon) that the next two days will see rain and thunderstorms is likely to be associated with lower consumer demand, while an indication by the electronic computing device 120 that a snow storm is expected in the next two days is likely to be associated with a higher consumer demand for fresh food products at the grocery location 110. In some embodiments, historical weather data may be stored in the central database 185 and used to forecast fresh product production quantities at least in part based on the historical weather data associated with the grocery location 110.

In some embodiments, the user interface 250 of the electronic computing device 120 may be configured to include a running ticker that provides various additional information relating to the fresh food products to a user. Such additional information may include, but is not limited to holiday promotions and plans, safety/product recall issues, modular changes, as well as any other merchandising news relevant to the products offered by the fresh food departments 130, 140, 150, and 160 of the grocery location 110.

In one approach, various financial and/or performance historical data may be logged at the grocery location 110 and stored in an inventory management database (i.e., local database 175 and/or central database 185) to permit evaluation and analysis of financial trends at the grocery location 110. Such financial trends may be retrieved from the database 175 and/or database 185 by the electronic computing device 120 and displayed on the display screen 260. The user may then be permitted to navigate the displayed data using the inputs 270 of the electronic computing device 120.

For example, data points including one or more of total dollar amount received based on total sales of the product, total number of the product sold, total number of the product thrown away without being sold, and total number and amounts of price markdowns for the product during a course of ten weeks that precede a current week may be logged and stored in the local database 175 and/or central database 185. This stored financial and/or performance data pertaining to the products sold by the fresh food departments 130, 140, 150, and 160 of the grocery location 110 may be used, for example, to generate one or more reports indicating financial trends at the grocery location 110 for the past 4, 6, 10, or 52 weeks, which allow for monitoring of overall performance by the grocery location 110, and facilitates the forecasting of demand for the products at the fresh food departments 130, 140, 150, and 160 of the grocery location 110 as will be discussed in more detail below.

In some embodiments, the user interface 250 of the electronic computing device 120 is software-implemented and permits users to view and print the production forecasts for the fresh food departments 130, 140, 150, and 160 of the grocery location 110. Optionally, the user interface 250 may be configured to log the identity of each user that accesses the user interface 250 of the electronic computing device 120, and log each instance when the product production forecasts for the fresh food departments 130, 140, 150, and/or 160 are printed by a user using the electronic computing device 120.

In some embodiments, the user interface 250 of the electronic computing device 120 may be configured to include a chatroom-type interface configured to permit users (i.e., department managers, associates, or the like) at the grocery location 110 to communicate with managers and/or associates at one or more other grocery locations and/or with support personnel at the central server 180 or another location regarding various topics, including but not limited to discussions relating to past product demand, forecasting product demand and/or understanding the forecasts, using the system 100, possible improvements to the system 100 and the like.

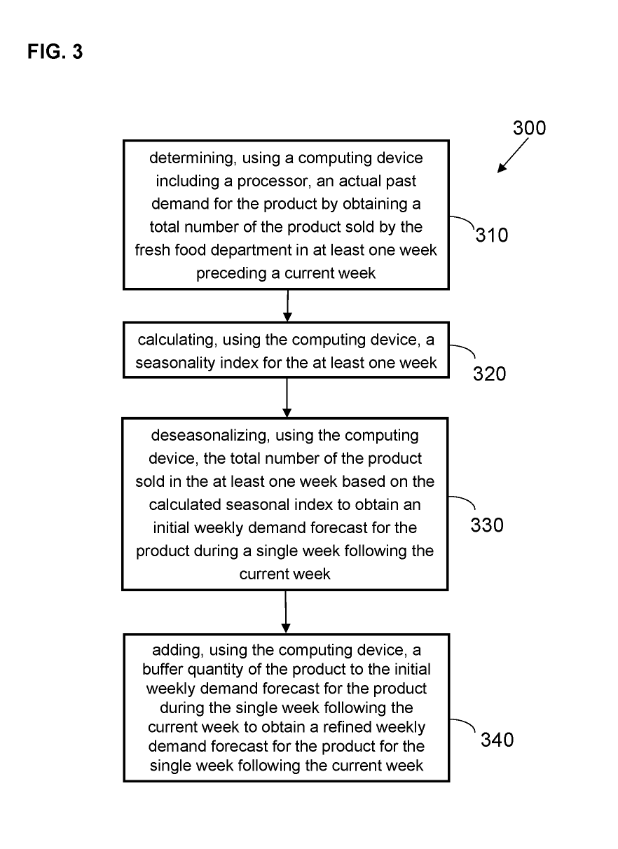

With reference to FIGS. 1-3, one method 300 of operation of the system 100 to forecast consumer demand for products at the fresh food department (e.g., 130, 140, 150, or 160) of the grocery location 110 will now be described. For exemplary purposes, the method 300 is described in the context of the system of FIG. 1, but it is understood that embodiments of the method may be implemented in this or other systems. As shown in FIG. 3, the exemplary method 300 includes determining, using a computing device (e.g., electronic computing device 120), an actual past demand for the product at the grocery location 110 by obtaining a total number of the product sold by the fresh food department (e.g., 130, 140, 150, or 160) of the grocery location 110 in one or more weeks preceding a current week (step 310).

In some embodiments, determining the actual past demand for the fresh product at the grocery location 110 includes communicating from the electronic computing device 120, either to the local server 170 or directly to the central server 180 to obtain product-related data from the local database 175 or the central database 185, respectively. The product-related data obtained from the local database 175 and/or the central database 185 may include actual past demand for the product at the grocery location 110, as evidenced by actual past sales of the product at the grocery location 110. For example, the local database 175 and/or central database 185 may include data related to consumer demand for a product of interest at the grocery location 110, such as the total units/pounds of the product sold at the grocery location 110 on any given day or per hour, for example. Thus, the local database 175 and/or central database 185 may be configured to keep a running consumer demand for the product of interest at the grocery location 110 such that the actual demand historical data obtained by the electronic computing device 120 from the local database 175 or central database 185 may include actual demand data pertaining to sales data over a certain period of time, such as, for example, four weeks, six weeks, nine weeks, or 52 weeks.

With reference to FIG. 3, the method 300 further includes calculating, using the computing device (e.g., electronic computing device 120), a seasonality index for the one or more weeks preceding the current week (step 320). The seasonality index can advantageously provide an indication of seasonality of consumer demand in terms of quantities of the food product sold at the grocery location 110. In one approach, the seasonality index is calculated using one year of historical sales data of the product at the grocery location 110. In particular, for a grocery location 110 that has been open for more than one year, the seasonality index may be calculated by dividing the quantity of the food product sold at the grocery location 110 (store level) during the week of interest (i.e., the week following the current week for which the product demand is being forecast) of the preceding year by the average quantity of the food product sold at the grocery location 110 during all weeks of the preceding year. For example, if the bakery department 150 at the grocery location 110 sold 1000 cakes during a week of the present year corresponding to the week of interest and the weekly average for cakes sold at the grocery location 110 based on all 52 weeks of the preceding year was 500, then the seasonality index would be 1000 divided by 500 or 2.

For a grocery location 110 that has been open for less than one year, since historical data for one full year is not available, the seasonality index may be calculated by dividing the quantity of the food product sold at grocery locations in the region of the grocery location 110 (region level) during the week of interest of the preceding year by the average quantity of the food product sold at the regional grocery locations during all weeks of the preceding year. In some embodiments, the seasonality index for sales of a product at the fresh food departments 130, 140, 150, and 160 of the grocery location 110 may be calculated at the store level if sales data for the grocery location 110 is available for at least 90% of the weeks of the preceding calendar year, and at the regional level if sales data for the grocery location 110 is not available for at least 90% of the weeks of the preceding calendar year.

In one approach, after the seasonality index for the week of interest is calculated, the next step of the exemplary method 300 of forecasting the demand for the fresh product of interest includes deseasonalizing, using the electronic computing device 120, the total number of the product sold during the one or more weeks based on the calculated seasonal index to obtain an initial weekly demand forecast for the product during a single week following the current week (step 330). Deseasonalizing the total number of products sold during the week of interest of the preceding year provides for a more accurate forecasting of the actual consumer demand for the product. For example, if the bakery department 150 at the grocery location 110 sold 1000 cakes during the week of interest of the preceding year and the seasonality index was determined to be 2 in step 320 described above, the deseasonalizing step 330 would indicate to a user that only 500 cakes (i.e., 1000 divided by 2) are needed to be produced for next week of the present year. In other words, the demand for cakes at the bakery department 150 of the grocery location 110 for the week of interest of the present year, based on the deseasonalizing of the past actual sales data of 1000 cakes (obtained from the local database 175 or the central database 185) with a seasonality index of 2 is 500 cakes. In some embodiments, the calculation of the seasonality index and the deseasonalizing take into account both holiday and non-holiday weeks.

In some embodiments, determining the actual demand for the fresh product of interest at the grocery location 110 may include obtaining, from the local database 175 or the central database 185, a total number of the product of interest sold by the corresponding fresh food department (e.g., 130, 140, 150, or 160) of the grocery location 110 during nine consecutive weeks immediately preceding the current week (which in turn immediately precedes the week of interest for which the consumer demand is being forecast), and extrapolating a total number of the product of interest forecast to be sold during the current week. For example, obtaining a nine week history of actual sales of the fresh product of interest by the fresh food department (e.g., 130, 140, 150, or 160) of the grocery location 110 provides an accurate historical trend to for the processor of the control circuit 210 of the electronic computing device 120 to extrapolate product demand/sales data for the current week, and forecast demand for the product of interest for the week of interest that immediately follows the current week. In one approach, instead of, or in addition to obtaining data including a nine-week history of actual sales of the fresh product of interest at the grocery location 110 and extrapolating week ten, actual sales data of the product of interest for fifty-two weeks prior to the week for which the product demand is to be forecast may be obtained from the local database 175 or the central database 185, and such data may then be analyzed for seasonal trends.

In another approach, instead of extrapolating the sales numbers for the current week based on the nine-week history of actual sales of the fresh product of interest at the grocery location 110, a total number (i.e., units or pounds) of the product of interest sold by the fresh food department (e.g., 130, 140, 150, or 160) day-by-day during four weeks preceding the current week may be obtained from the local database 175 or the central database 185, which then permits the processor of the control circuit 210 of the electronic computing device 120 to calculate the ratio of average Saturday to Thursday sales to Friday sales during these four weeks. Then, the total number of sales of the product of interest during the current week can be divided by this calculated ratio to get a total extrapolated current week sales of the product of interest, and the total extrapolated current week sales of the product of interest can be added as week ten following the nine consecutive weeks immediately preceding the current week. This approach can provide a ten week historical trend indicating consumer demand for the fresh product of interest at the grocery location 110 based on which consumer demand for the fresh product of interest at the fresh food departments 130, 140, 150, and 160 of the grocery location 110 for the week immediately following the current week may be accurately forecasted.

In some embodiments, after obtaining a forecast of demand for the product of interest during the week of interest (i.e., the week that immediately follows the current week) based on a ten-week history of actual sales of the product of interest as discussed above, a confidence level in the accuracy of the forecast demand may be determined. For example, determining the confidence level in the accuracy of the forecast may include calculating a variance by dividing a standard deviation obtained based on a deseasonalized total number of product of interest sold at the grocery location 110 during each of the ten consecutive weeks by a mean obtained based on a deseasonalized total number of the product of interest sold at the grocery location 110 during each of the ten consecutive weeks. Then, if the variance is greater than a predetermined threshold (e.g., from about 0.3 to about 0.7 in one approach, from about 0.4 to about 0.6 in another approach, and 0.5 in yet another approach), the demand forecast for the product of interest for the week for which the consumer demand is being forecast (i.e., the week immediately following the current week) may be calculated based on a six week moving average of weekly sales of the product of interest multiplied by the seasonal index. Conversely, if the variance is less than the above-described exemplary predetermined threshold, the demand forecast for the product of interest for the week for which the consumer demand is being forecast may be calculated based on a linear regression analysis, which may include building a regression model based on actual consumer demand data for the product of interest obtained by the electronic computing device 120 either from the local database 175 or the central database 185.

In some embodiments, if the P value of the linear regression analysis is less than a predetermined value (e.g., from about 0.1 to about 0.5 in one approach, from about 0.2 to about 0.4 in another approach, and 0.3 in yet another approach), the demand forecast for the fresh product of interest week for which the consumer demand is being forecast may be calculated based on a six week moving average of weekly sales of the product multiplied by the seasonal index. In other embodiments, if the P value of the linear regression analysis is less than the above-described exemplary predetermined value and a trend coefficient is less than zero, the demand forecast for the week for which the consumer demand is being forecast may be calculated based on a maximum of the six week moving average forecast and the linear regression forecast. In other embodiments, if the P value of the linear regression analysis is less than the above-described exemplary predetermined value and a trend coefficient is greater than zero, the demand forecast for the week for which the consumer demand is being forecast may be calculated based on an estimated β value obtained during the linear regression analysis multiplied by the trend coefficient plus an intercept value obtained during the linear regression analysis times the seasonal index.

The exemplary method 300 of forecasting demand for a product of interest at the grocery location 110 further includes adding, using the electronic computing device 120, a buffer quantity of the product of interest to the initial weekly demand forecast for the product during the single week following the current week to obtain a refined weekly demand forecast for the product for the single week following the current week (step 340). In one approach, the forecast demand for the product of interest is refined by taking the weighted amount of the forecast and a buffer quantity at an item level, with the refined forecast being determined as a minimum standard deviation value of a total number of the product of interest thrown away during each of four weeks preceding the week of interest (i.e., the week that immediately follows the current week) for which the demand forecast is being calculated. For example, if the electronic computing device 120 at the bakery department 150 of the grocery location 110 forecasts, based on the methodology described above, a consumer demand of 100 units of a fresh product of interest for the upcoming week and it is determined that, over the past four weeks, five, ten, fifteen, and twenty units of this product (i.e., an average of 12 units per week) were not sold but thrown away for various reasons, the demand forecast for the fresh product of interest generated by the processor of the control circuit 210 of the electronic computing device 120 would be 100 (units forecast to be demanded)+12 (average units thrown away in the past four weeks)=112 (units of the product of interest forecast to be produced to account for the throws).

In one optional approach, instead of, in addition to generating a weekly forecast of consumer demand for a fresh product of interest at a department (e.g., 130, 140, 150, or 160) of the grocery location 110 for the week of interest, a daily consumer demand forecast for the fresh product of interest over the week of interest may be generated based on the refined single week demand forecast obtained in step 340. For example, the daily demand forecast for the product of interest may include an indication of a total number of the product of interest forecast to be demanded at the fresh food departments 130, 140, 150, and 160 of the grocery location 110 on each day of next week for which the demand is being forecast (e.g., total product quantity to be produced on Monday, total product quantity to be produced on Tuesday, total product quantity to be produced Wednesday, etc.). In another approach, the daily demand forecast for the product of interest may include an indication of a percentage of the refined single week demand forecast represented by the daily demand forecast for the product of interest on each day of next week for which the demand is being forecast (e.g., percentage of total weekly product quantity to be produced on Monday, percentage of total weekly product quantity to be produced on Tuesday, percentage of total weekly product quantity to be produced on Wednesday, etc.).

In one exemplary situation, if it is determined, based on historical actual demand analysis (e.g., by the processor of the control circuit 210 of the electronic computing device 120), that in the four weeks preceding the week of interest for which demand is being forecast, the total number of pounds of beef steak sold by the meat department 160 of the grocery location 110 was 135, and the daily sales were as follows: Monday (12 pounds), Tuesday (16 pounds), Wednesday (20 pounds), Thursday (17 pounds), Friday (10 pounds), Saturday (28 pounds), and Sunday (32 pounds), then the percent daily contribution may be calculated by the processor of the control circuit 210 of the electronic computing device 120 via dividing the daily values (i.e., 12, 16, 20, 17, 10, 28, and 32) of the product sold by the total weekly value (i.e., 135) to obtain the following daily percentage contributions: Monday (8.8%), Tuesday (11.8%), Wednesday (14.8%), Thursday (12.6%), Friday (7.4%), Saturday (20.7%), and Sunday (23.9%).

Then, for example, if it is forecasted, based on the past actual demand, that 204 pounds of beef steak will be demanded by the consumers next week at the meat department 160 of the grocery location 110, and that the daily percentage contribution is as follows: Monday (8.8%), Tuesday (11.8%), Wednesday (14.8%), Thursday (12.6%), Friday (7.4%), Saturday (20.7%), and Sunday (23.9%), then the corresponding daily forecast for the beef steak would be calculated by the processor of the control circuit 210 of the electronic computing device 120 as follows: Monday (18.2 pounds), Tuesday (24.3 pounds), Wednesday (30.2 pounds), Thursday (25.7 pounds), Friday (15.1 pounds), Saturday (42.2 pounds), and Sunday (48.8 pounds).

In one approach, if an average weight of a pack of the product of interest (e.g., beef steak) is known in advance (e.g., obtained from the local database 175 or the central database 185) and/or determined on-site at the grocery location 110, the daily demand forecast for the product for each day of the week of interest may be converted by the processor of the control circuit 210 of the electronic computing device 120 to a number of packs of the product forecast to be demanded on each day of the week of interest. For instance, in the above example, if the average weight of a pack of the beef steak is 8.1 pounds, given that the daily beef steak weight demand forecast is: Monday (18.2 pounds), Tuesday (24.3 pounds), Wednesday (30.2 pounds), Thursday (25.7 pounds), Friday (15.1 pounds), Saturday (42.2 pounds), and Sunday (48.8 pounds), then the beef steak pack demand forecast is: Monday (18.2 divided by 8.1 pounds or 2 packs), Tuesday (24.3 divided by 8.1 pounds or 3 packs), Wednesday (30.2 divided by 8.1 pounds or 4 packs), Thursday (25.7 divided by 8.1 pounds or 3 packs), Friday (15.1 divided by 8.1 pounds or 2 packs), Saturday (42.2 divided by 8.1 pounds or 5 packs) and Sunday (48.8 divided by 8.1 pounds or 6 packs).

It will be appreciated that during the generation of the daily demand forecast for the product of interest at the grocery location 110, a total number of the product of interest sold by any of the fresh food departments (i.e., 130, 140, 150, and/or 160) by week, day, and hour during four, six, or ten weeks preceding a current week may be obtained from the local database 175 and/or the central database 185, and displayed to a user via the user interface 250 of the electronic computing device 120. Such data may provide for a desired indication of demand for the fresh product of interest from a big picture stand point (e.g., weekly) to a more precise standpoint (daily and/or hourly).

It will appreciated that the forecast of the consumer demand for fresh products at the fresh food departments 130, 140, 150, and 160 of the grocery location 110 may be performed without requiring any calculations or analysis by the processor of the control circuit 210 of the electronic computing device 120, and that the system 100 may be configured such that the local server 170 and/or central server 180 is configured to communicate historical data (e.g., relating to past actual sales at the grocery location 110) stored in its respective database 175 and 185 to an electronic computing device remote to the grocery location 110 and in communication with the electronic computing device 120. The electronic computing device remote to the grocery location 110 may be configured as a Greenplum-type database analyzer device. In such embodiments, the production forecast for the fresh product of interest at the grocery location 110 may be generated by the electronic computing device remote to the grocery location 110 and may be stored in the database 175 or 185 of the local server 170 or central server 180 until a time when a user logs into the electronic computing device 120 and uses the electronic computing device 120 to request and retrieve the predetermined weekly forecast for the fresh product of interest from the database 175 or 185.

It will be appreciated that the production forecast for the fresh product of interest at the grocery location 110 does not have to be generated by the electronic computing device remote to the grocery location 110 and stored in the database 175 or 185 prior to the time when the user logs into the electronic computing device 120 and uses the electronic computing device 120 to request the weekly forecast for the fresh product of interest from the database 175 or 185—instead, the production forecast for the fresh product of interest at the grocery location 110 may be generated by the electronic computing device remote to the grocery location 110 directly in response to receiving a fresh product production forecast request from the electronic computing device 120.

As described herein, the system and methods described herein provide for easy and efficient computer-implemented forecasting of consumer demand for fresh food products at grocery locations while minimizing inaccuracies associated with predicting consumer demand based on simply historical averages. This improves optimization of on-hand inventory of products at the fresh food departments of grocery locations to meet the anticipated consumer demand for next week, and reduces both financial losses associated with overproduction (and the associated throw away of excess products that were not sold during the current week) and losses of reputation associated with underproduction (and the associated consumer unhappiness that a product desired by the consumers is not available at the grocery location).

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A computer-implemented method of forecasting consumer demand for a product at a fresh food department of a grocery store, the method comprising:
determining, using a computing device including a processor, an actual past demand for the product by obtaining a total number of the product sold by the fresh food department in at least one week preceding a current week;
calculating, using the computing device, a seasonality index for the at least one week;
deseasonalizing, using the computing device, the total number of the product sold in the at least one week based on the calculated seasonal index to obtain an initial weekly demand forecast for the product during a single week following the current week; and
adding, using the computing device, a buffer quantity of the product to the initial weekly demand forecast for the product during the single week following the current week to obtain a refined weekly demand forecast for the product for the single week following the current week.

2. The method of claim 1, further comprising generating a daily demand forecast for the product based on the refined weekly demand forecast for the product for the single week following the current week.

3. The method of claim 2, wherein the daily demand forecast for the product includes an indication of one of a total number of the product forecast to be demanded on each day of the single week, and a percentage of the refined weekly demand forecast represented by the daily demand forecast for the product on each day of the single week.

4. The method of claim 2, further comprising determining an average weight of a pack of the product, and based on the determined average weight of the pack of the product, converting, via the computing device, the daily demand forecast for the product for each day of the single week to a number of packs of the product forecast to be demanded on each day of the single week.

5. The method of claim 2, wherein the generating of the daily demand forecast for the product further comprises obtaining a total number of the product sold by the fresh food department by at least one of week, day, and hour during four weeks preceding a current week.

6. The method of claim 1, wherein the calculating of the seasonal index by the computing device includes dividing a total number of the product sold during the at least one week by an average number of the product sold per week in a preceding year.

7. The method of claim 6, wherein the deseasonalizing of the total number of the product sold in the at least one week comprises dividing, using the computing device, the total number of the product sold during the at least one week by the calculated seasonal index.

8. The method of claim 7, wherein the determining of the actual demand further comprises obtaining a total number of the product sold by the fresh food department during nine consecutive weeks immediately preceding the current week and extrapolating a total number of the product forecast to be sold during the current week.

9. The method of claim 8, wherein the extrapolating further comprises obtaining a total number of the product sold by the fresh food department by day during four weeks preceding the current week, calculating a ratio of average Saturday to Thursday sales to Friday sales during the four weeks, dividing a total number of sales of the product during the current week by the calculated ratio to get a total extrapolated number of sales of the product for the current week, and adding the total extrapolated number of sales of the product for the current week as week ten following the nine consecutive weeks immediately preceding the current week.

10. The method of claim 9, further comprising determining a confidence level in an accuracy of a demand forecast based on ten consecutive weeks immediately preceding the single week following the current week for which the consumer demand is being forecast.

11. The method of claim 10, wherein the determining of the confidence level in the accuracy of the forecast includes calculating a variance by dividing a standard deviation obtained based on a deseasonalized total number of sales of the product during each of the ten consecutive weeks by a mean obtained based on a deseasonalized total number of sales of the product during each of the ten consecutive weeks.

12. The method of claim 11, further comprising calculating a demand forecast for the single week following the current week for which the consumer demand is being forecast based on a six week moving average of weekly sales of the product multiplied by the seasonal index.

13. The method of claim 11, further comprising calculating a demand forecast for the single week following the current week for which the consumer demand is being forecast based on a linear regression analysis.

14. The method of claim 13, further comprising, calculating a demand forecast fort the single week following the current week for which the consumer demand is being forecast based on a six week moving average of weekly sales of the product multiplied by the seasonal index.

15. The method of claim 14, further comprising calculating a demand forecast for the single week following the current week for which the consumer demand is being forecast based on a maximum of the six week moving average forecast and the linear regression forecast.

16. The method of claim 14, further comprising calculating a demand forecast for the single week following the current week for which the consumer demand is being forecast based on an estimated β value obtained during the linear regression analysis multiplied by the trend coefficient plus an intercept value obtained during the linear regression analysis times the seasonal index.

17. The method of claim 1, wherein the buffer quantity of the product is calculated as a minimum standard deviation value of a total number of the product thrown away during each of four weeks preceding the current week.

18. The method of claim 1, wherein the calculating the seasonal index for the at least one week further comprises calculating the seasonal index based on dividing the total number of the product sold during the at least one week at the grocery store by an average total number of the product sold at the grocery store per week of a preceding year if weekly sales data for the grocery store are available for at least 90% of weeks of the preceding year, and calculating the seasonal index based on dividing the total number of the product sold during the at least one week at the grocery store by an average total number of the product sold in a region where the grocery store is located per week of a preceding year if weekly sales data for the grocery store are not available for at least 90% of weeks of the preceding year.

19. The method of claim 1, further comprising logging at least one of total dollar amount received based on total sales of the product, total number of the product sold, total number of the product thrown away without being sold, and total number and amounts of price markdowns for the product during a course of ten weeks that precede a current week, and generating a report indicating financial trends at the grocery store for the last ten weeks.

20. The method of claim 1, further providing a computer interface including a chatroom permitting personnel at the grocery store to communicate with one of a central location and other grocery stores regarding at least the refined demand forecast for the product.

21. A computer-based system for forecasting consumer demand for a product at a fresh food department of a grocery store, the system comprising:
a computing device including a control circuit having a processor;
a network interface configured to retrieve a total number of the product sold by the fresh food department from a database;
a memory coupled to the control circuit and storing computer instructions that when executed by the control circuit are configured to:
determine an actual past demand for the product by obtaining from the database the total number of the product sold by the fresh food department in at least one week preceding a current week;
calculate a seasonality index for the at least one week;
deseasonalize the total number of the product sold in the at least one week based on the calculated seasonal index to obtain an initial weekly demand forecast for the product during a single week following the current week; and
add a buffer quantity of the product to the initial weekly demand forecast for the product during the single week following the current week to obtain a refined weekly demand forecast for the product for the single week following the current week.
